(19) United States
(12) Patent Application Publication
(10) Pub. No.: US 2009/0133301 A1
(43) Pub. Date: May 28, 2009

(54) DIFFERENTIATED FAR-FIELD AND NEAR-FIELD ATTENTION GARNERING DEVICE AND SYSTEM

(75) Inventors: Sunit SAXENA, Monte Sereno, CA (US); Anurag Goel, Foster City, CA (US)

Correspondence Address: DLA PIPER LLP (US ), 2000 UNIVERSITY AVENUE, EAST PALO ALTO, CA, 94303-2248, US

(73) Assignee: Altierre Corporation

(21) Appl. No.: 11/945,227

(22) Filed: Nov. 26, 2007

(51) Int. Cl. G09F 9/30

(52) U.S. Cl. 40/446

(57) ABSTRACT

An attention garnering device, system and method are provided wherein the element has a display and at least one attention element that attracts a user to view the display of the element.

### FIELD

This invention relates to attention garnering devices to be used in conjunction with signage applications such that the device appears differentiated in far-field and near-field viewing.

### BACKGROUND

Various devices exist that attempt to attract a consumer's attention to a particular product. For example, supermarkets and other stores use visual or audible cues to attract the attention of a consumer. For example, a store may have a sign that indicates a sale of an item or a deal for a particular item. More recently, stores have used electronic means, such as a blinking light or light emitting diode (LED), to attract the consumer's attention to a particular item or a piece of paper that has information about the particular item. However, these devices with electronic means do not typically have an electronic display of the relevant sale/deal for the item and the light or LED is often to intrusive so that the consumer is actually not inclined to look at the offer for the item or product. In addition, these electronic devices do not have a long lifetime of operation and the offer for the item or product cannot be quickly and easily updated. Thus, it is desirable to provide an attention garnering device and system that overcomes the limitations of the above systems and devices and it is to this end that the present invention is directed.

### BRIEF DESCRIPTION OF THE DRAWINGS

FIG. 1 illustrates an example of an embodiment of an attention garnering device;

FIGS. 2-11 illustrate examples of other embodiments of an attention garnering device;

FIG. 12 illustrates an example of a hardware circuit implementation of the attention garnering device; and

FIGS. 13A-13AA illustrate examples of the use of the attention garnering device in an environment, such as a store.

### DETAILED DESCRIPTION OF ONE OR MORE EMBODIMENTS

The invention is particularly applicable to an attention garnering device, system and method with the specific hardware/software implementation described below that may be used in a store for item/product offers and it is in this context that the invention will be described. It will be appreciated, however, that the attention garnering device, system and method has greater utility since it may be implemented in other manners and it may be used for any application/industry/purpose in which it is desirable to be able to attract the attention of a user/consumer, etc. to a particular item, product, service, etc.

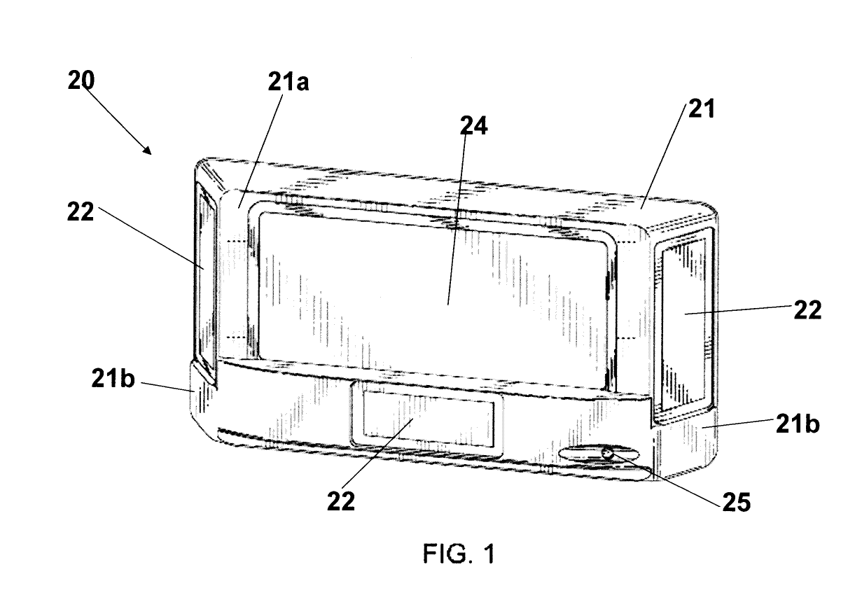

FIG. 1 illustrates an example of an embodiment of an attention garnering device 20. The attention garnering device 20 may include a housing 21 that has at least a front panel 21a and one or more side panels 21b (two are shown in this example) wherein the side panels are disposed at an angle with respect to the front panel with the effect that a relatively distant person viewing the attention garnering device known as a viewer) can see the side panels without necessarily clearly seeing the front panel, while a relatively close viewer can see the front panel without necessarily clearly seeing the side panels. The side panels attract attention, such as by emitting or modulating light or having a lit surface, displaying an image or color, or displaying a view that changes over time, such as for example a blinking, moving, or apparently moving image, a varying color or intensity, a varying character font or facing, or otherwise.

The housing 21 can be made of any suitably strong and/or damage resistant material or materials. Examples of the materials for the housing include, but are not limited to, impact resistant plastic, aluminum, a lightweight metal or any other material that reduces the chance of serious damage to the element components in the housing from an impact by customers and/or objects.

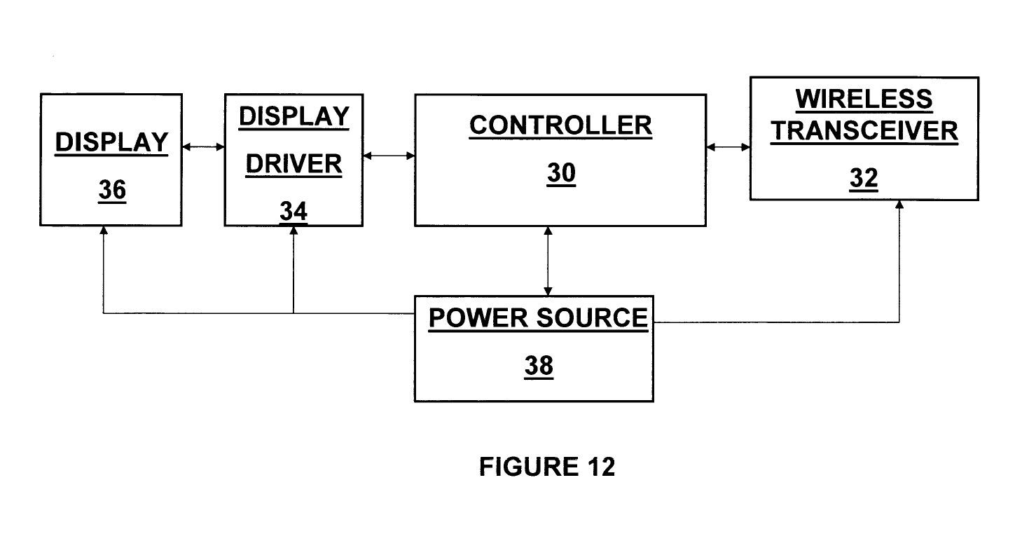

Thus, in one embodiment, the device 20 may include the housing 21, a display panel 24 on a front surface of the housing, one or more attention elements 22 at one or more locations on the housing (such as a lower portion of the front panel 21a and the two side panels 21b as shown in FIG. 1), a controller for the display panel and the attention elements (not shown), and a wireless communication module (not shown) as described in more detail below with reference to FIG. 12. In this embodiment, the sides of the housing are preferably angled. Each attention element may generate a visible signal that attracts a user wherein the visible signal may be generated by any suitable powered light source, for example but not limited to light bulbs, light emitting diodes (LEDs), and the like, but may also be a passive device that generates the visible signal based on ambient light at the location. Each attention element may also be a programmable or fixed/static pattern element (that displays a programmable of static message) so that the visible signal shows a message to the user such as “Sale”. Each attention element may be easily removed and replaced. In the embodiments, each attention element may have/generate a different color from the display color and may also flash a color to act as an attention getting mechanism. When the attention element 22 is implemented as a light emitting diode (LED), the LED can be powered by the controller to take advantage of the human eye's retained/persistent image due to the well known characteristics of the human eye's retina. Thus, the LED can be powered on for less than 0.03 seconds and then off for greater than 0.07 seconds (for each 1 second of visible signal) to conserve power of the device 20.

In some embodiments, the housing 21 has the front surface 21A that includes the display 24 facing across an aisle of a store, e.g., where a customer would stand if looking at the item and considering its purchase, while the attention elements 22 would face down the aisle of the store, e.g., where a customer would stand if looking or moving down the aisle toward the label so that the customer will see the attention elements 22 from down the aisle. In alternative embodiments, the housing 21 could be placed on a ceiling, on a rotating display rack, on a cash register or other mounted display rack, on a large-scale display, or otherwise to attract attention from a distance without disrupting the view of those customers near the housing.

The display panel 24 is provided to display product/item information. Such information can include, but is not limited to, some combination of text, price information, a bar code, an offer for a sale or discount and the like. The display panel 24 can be any suitable type of display, for example but not limited to a color or black and white liquid crystal display (LCD) panel.

The device 20 may also include one or more attraction garnering light elements 25 wherein these light elements 25 can be placed on any part of the device 20. Each light element may be a lamp, an LED, an LCD, a piece of colored material or active and/or programmable elements. The lights do not have to be light sources, as they could be mirrors or diffraction gratings, or could use ambient light.

The element can be used in many settings, including but not limited to a retail space. An example of such a use is described in U.S. patent Ser. No. 11/019,916, titled “Multiuse Wireless Display Tag Infrastructure and Methods,” owned by the same assignee and hereby incorporated by references as if fully set forth herein. In this embodiment, each device 20 may be recessed in a holder (not shown) that supports and protects the housing 21 while exposing the attention elements 22 to viewing. In this embodiment, the holder preferably fits into standard rails commonly used in retail at shelf edges and at various locations in the store wherever signage display is required. However, a holder does not have to be used.

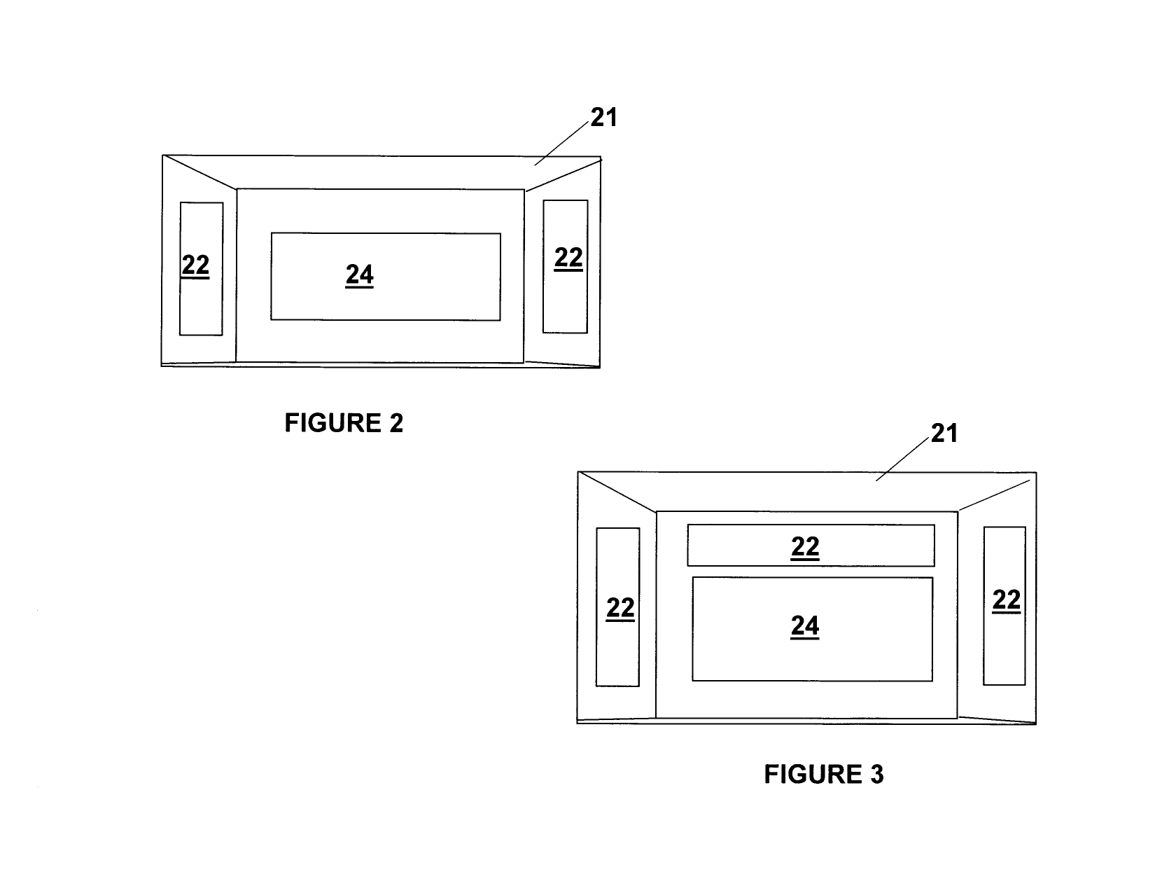

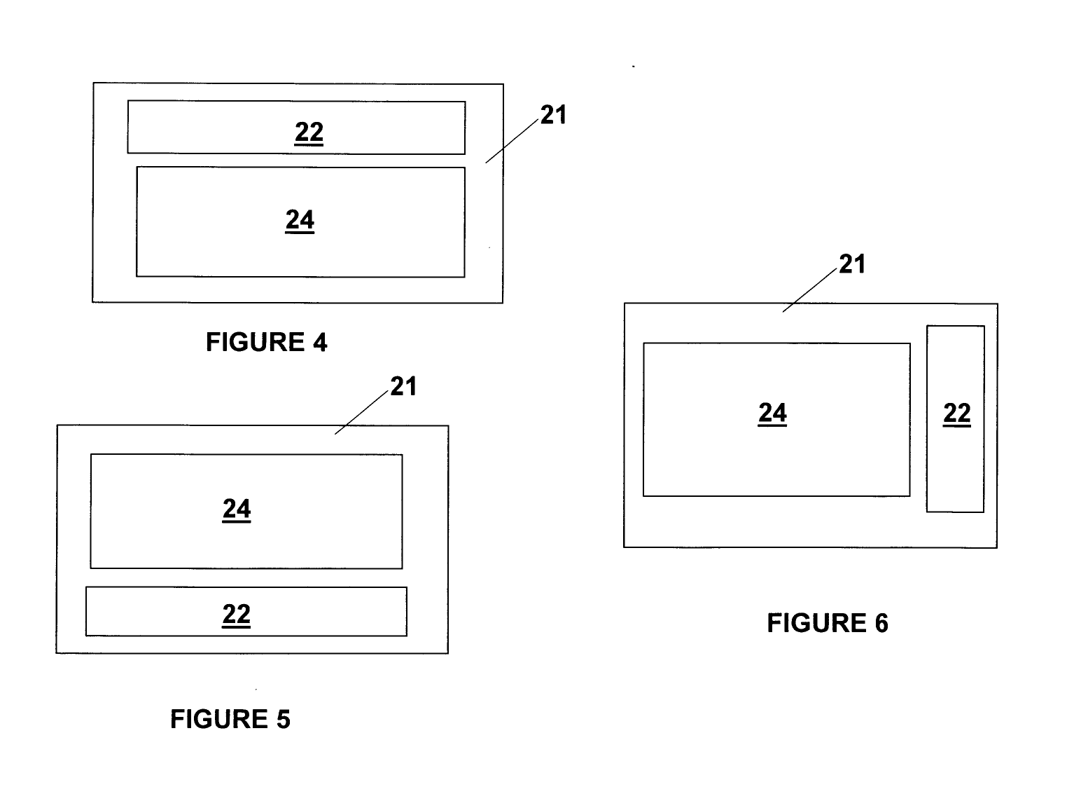

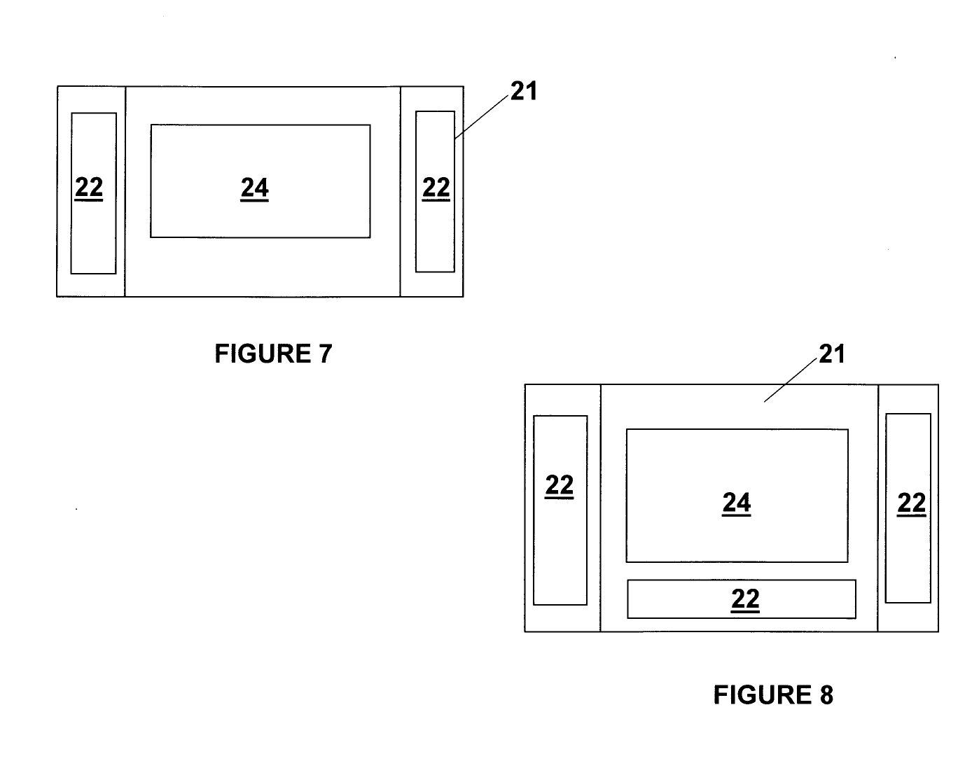

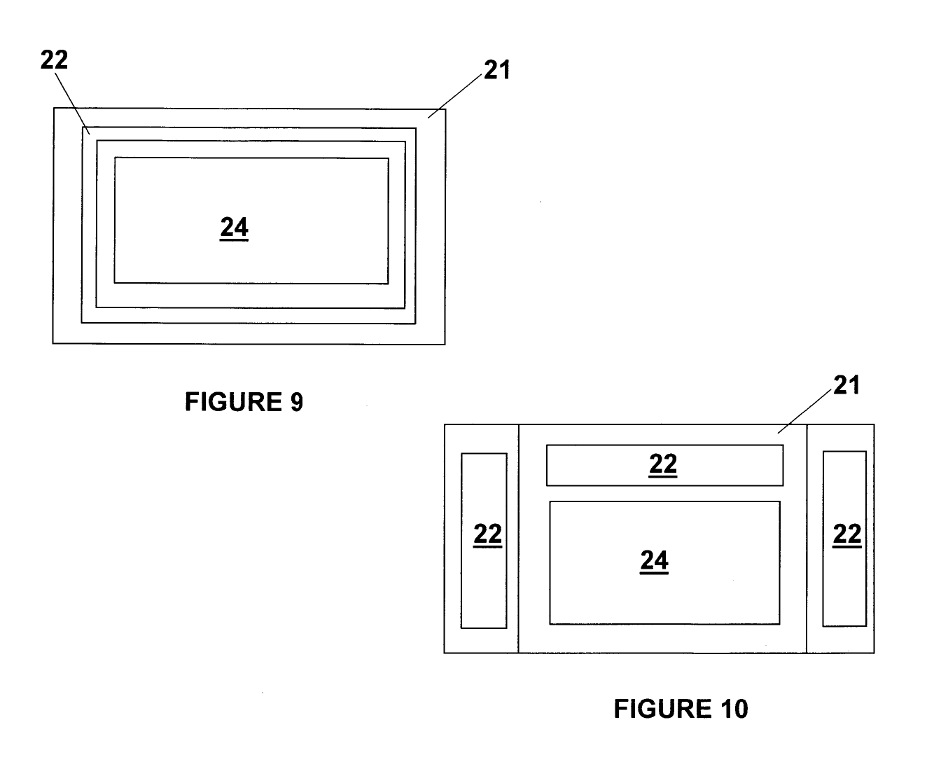

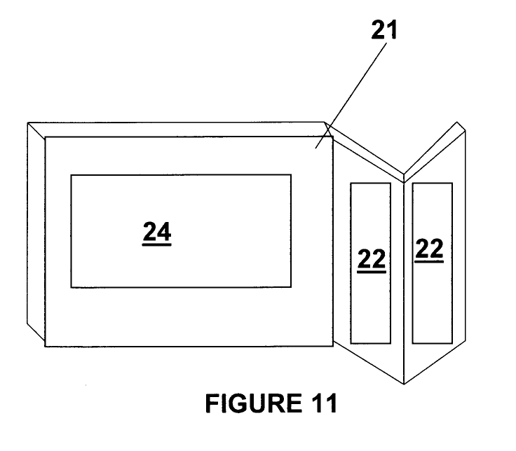

FIGS. 2-11 illustrate examples of other embodiments of an attention garnering device 20 with different configurations of the display 24 and the attention elements 22. The attention garnering device 20, however, is not limited to the embodiments shown in FIGS. 1-11 and may be an attention garnering device with at least a display 24 and at least one attention element 22. FIG. 2 shows another embodiment that has the display 24 on the front portion 21a and an attention element 22 on each side portion 21b. FIG. 3 shows another embodiment that has the display 24 on the front portion 21a with an attention element 22 above the display and an attention element 22 on each side portion 21b. FIG. 4-6 show embodiments in which the display 24 and an attention element 22 are both located on the front portion 21a of the element 21 in different orientations. FIGS. 7-8 show embodiments in which the display 24 is located on a front portion (along with an attention element 22 located below the display in FIG. 8) and two or more attention elements 22 are located on side portions that are not angled with respect to the display 24. In the embodiment shown in FIG. 9, the housing 21 has a front panel 21a wherein the display in located within the center of the front panel and the attention element 22 forms a border around the display as shown. FIG. 10 shows an embodiment in which the display 24 is located on a front portion with an attention element 22 above it and two or more attention elements 22 are located on side portions that are not angled with respect to the display 24. FIG. 11 illustrates another embodiment in which the device 20 has the housing 21 with a front portion 21a on which the display 24 is provided and a leaf portion 26 with at least a first leaf portion 26a and a second leaf portion 26b that each have an attention element 22. In the embodiment shown in FIG. 11, the leaf portion 26 is out of the plane with the rest of the device 20 so that the attention elements 22 stick out and may be more likely to attract attention while allowing the device 20 to be thinner and more compact.

In addition to the embodiments described above, the housing 21 may have one or more colored portions (located adjacent the display 24) that highlights particular important information displayed in the display. In addition, the attention element 22 of FIG. 9 may have segments so that one or more sides of the display 24 can be highlighted by one or more colors to highlight information shown on the display.

FIG. 12 illustrates an example of a hardware circuit implementation of the attention garnering device 20. As shown, the element may include a controller 30, such as a microcontroller, microprocessor or CPU, a wireless transceiver 32, such as radio frequency transmit/receive circuits, a display driver 34, a display device 36 (corresponding to the display 24) and a power source 38, such as a battery. In one embodiment, the controller 30 controls operation of the device 20, for example by controlling the state of the device 20 (e.g., on or off), controlling what is displayed on the display panel 36, controlling the state of the attention elements 22, and controlling the state of the light elements 25. In one embodiment, the controller 30 has software, microcode or embedded code in a memory that is executed by a processing unit that is part of the controller to perform the controlling operations. The controller may control the operations of the device 20 is different ways. In one embodiment, possible states for the attention elements 22 and the light element 25 include on, off, flashing, and any other attention-getting format. The control process can be based on a programmed time schedule, responsive to wireless or other communication with the device 20 or based on some other programmed or communicated information. The controller 30 also interfaces with the wireless control module 32 to receive and possibly to send data.

The display panel(s), attention element(s) 22, light element(s) 25, controller 30, and wireless communication module 32 are powered by the power source 38 that may be one or more internal batteries (not shown) and a rechargeable battery may be used in one embodiment.

The wireless communication module 32 uses wireless communication techniques, for example but not limited to radio frequency (RF) such as IEEE 802.11 techniques, infrared communication techniques, ultrasonic communication techniques, or some combination thereof. In one embodiment, an infrared port (not shown) may be used for infrared communication. Communication can be with a central controller, handheld devices, or other devices. Such communication can be used to update information and lighting displayed by the device 20, as well as possibly to report on status of the device 20.

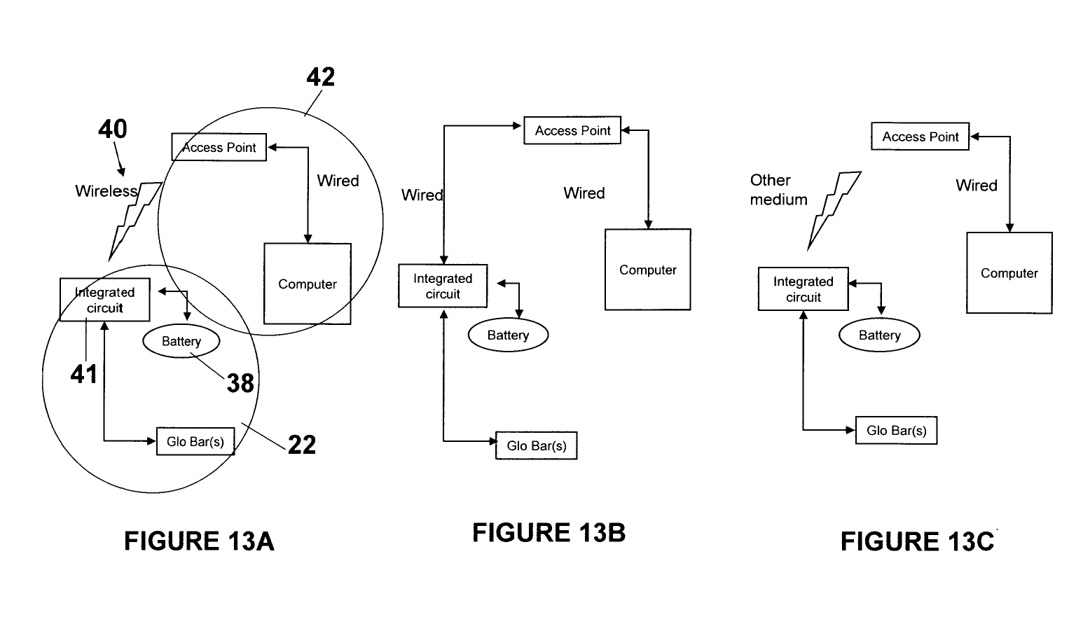

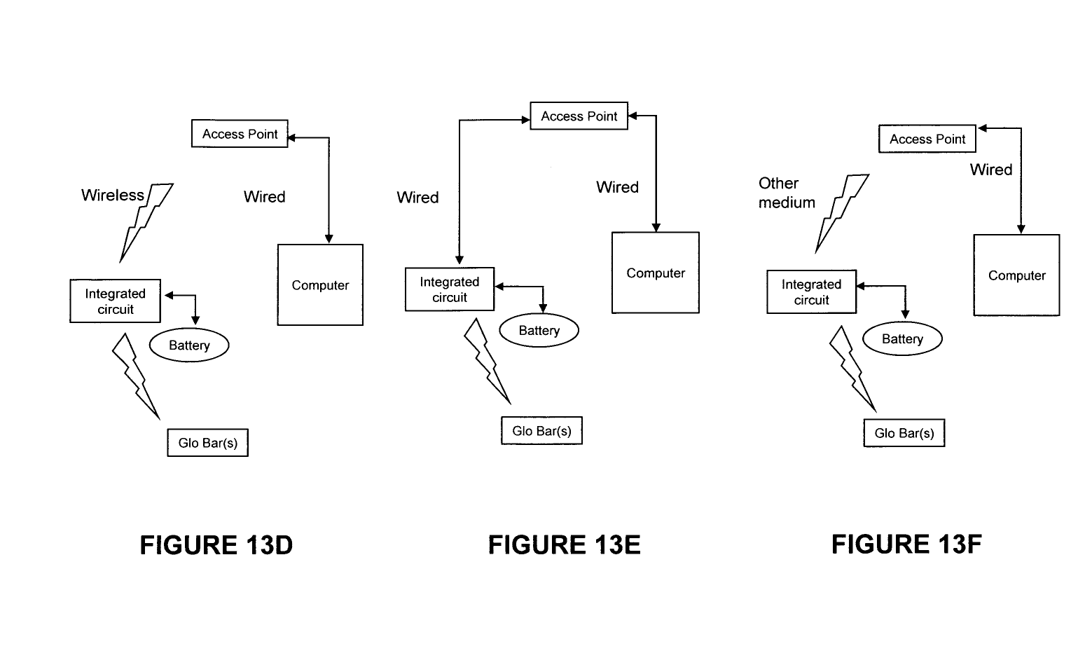

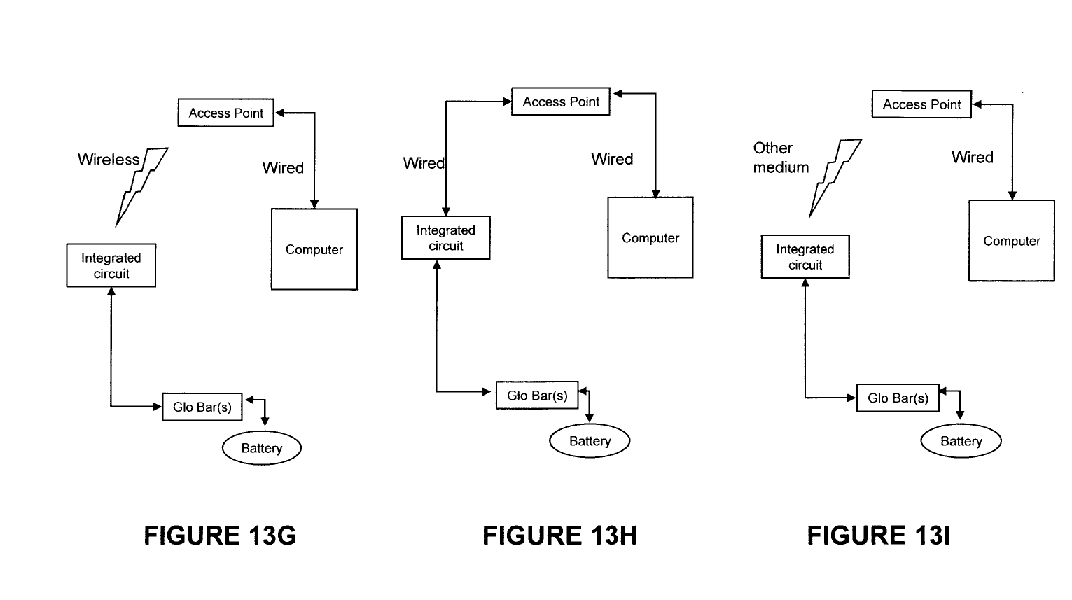

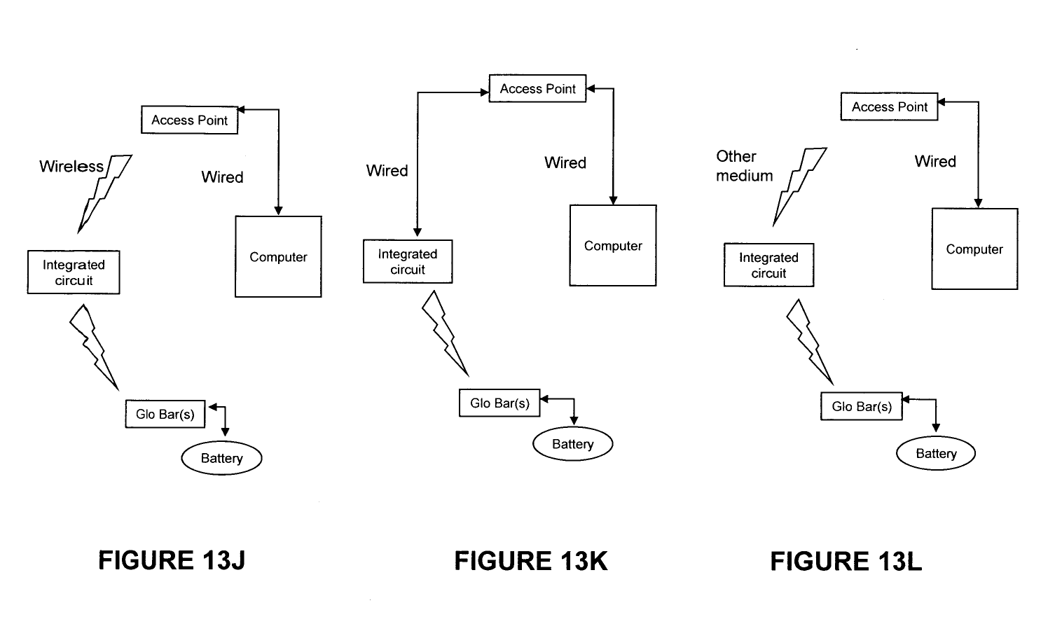

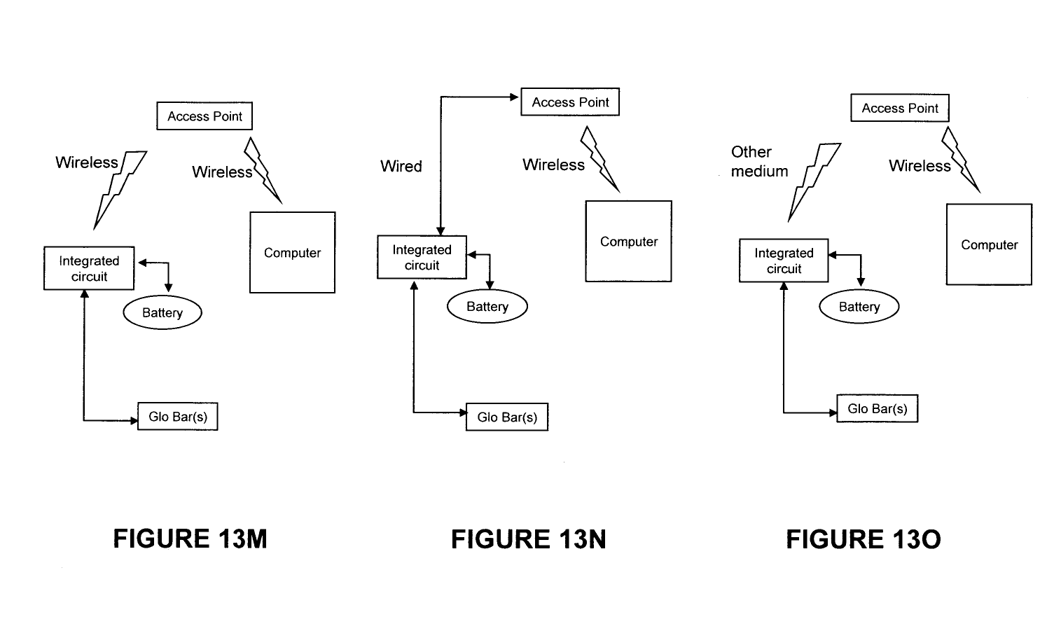

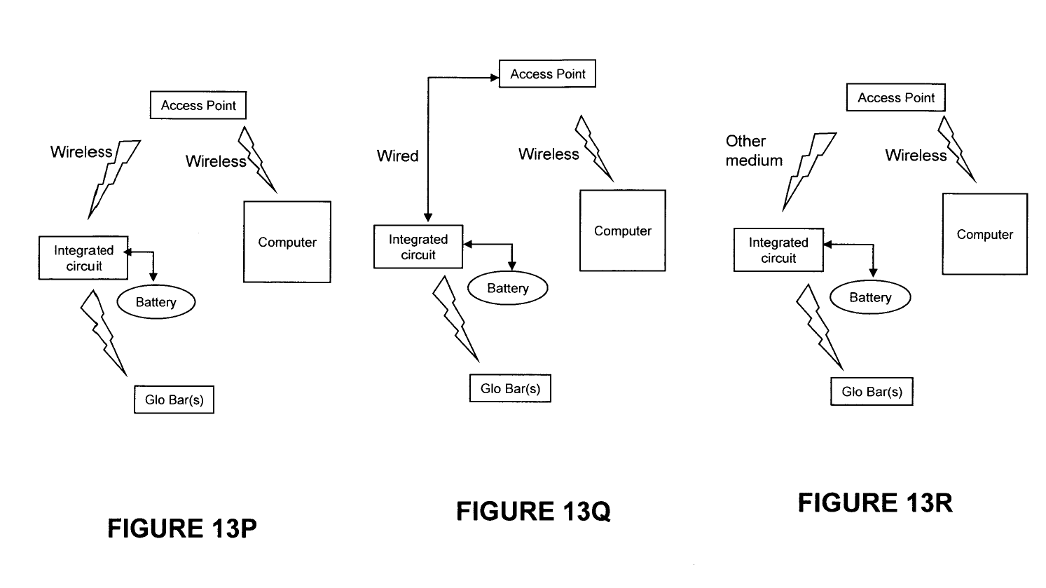

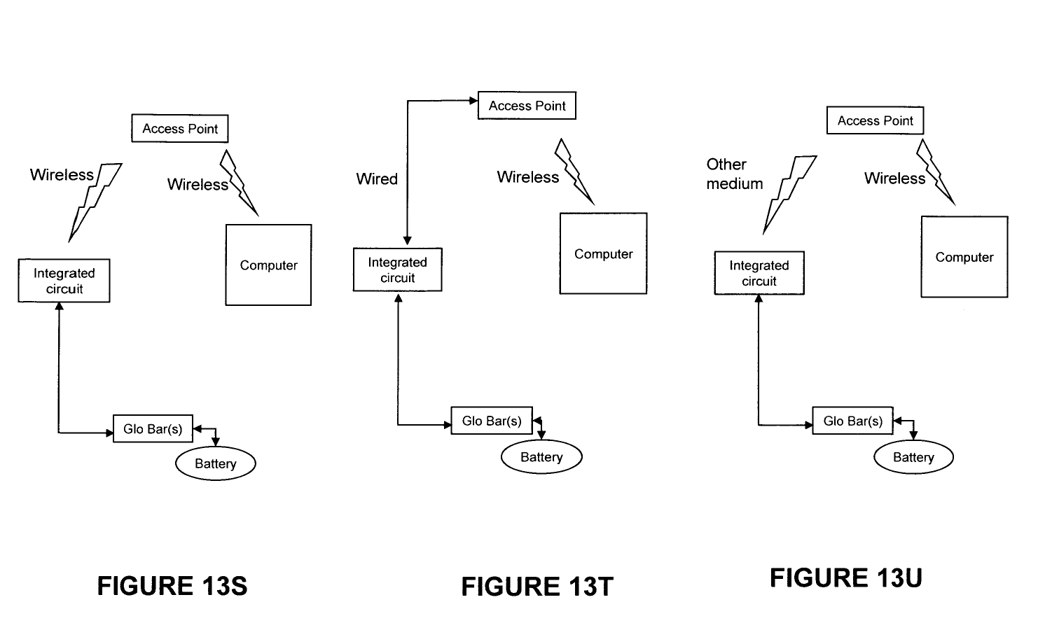

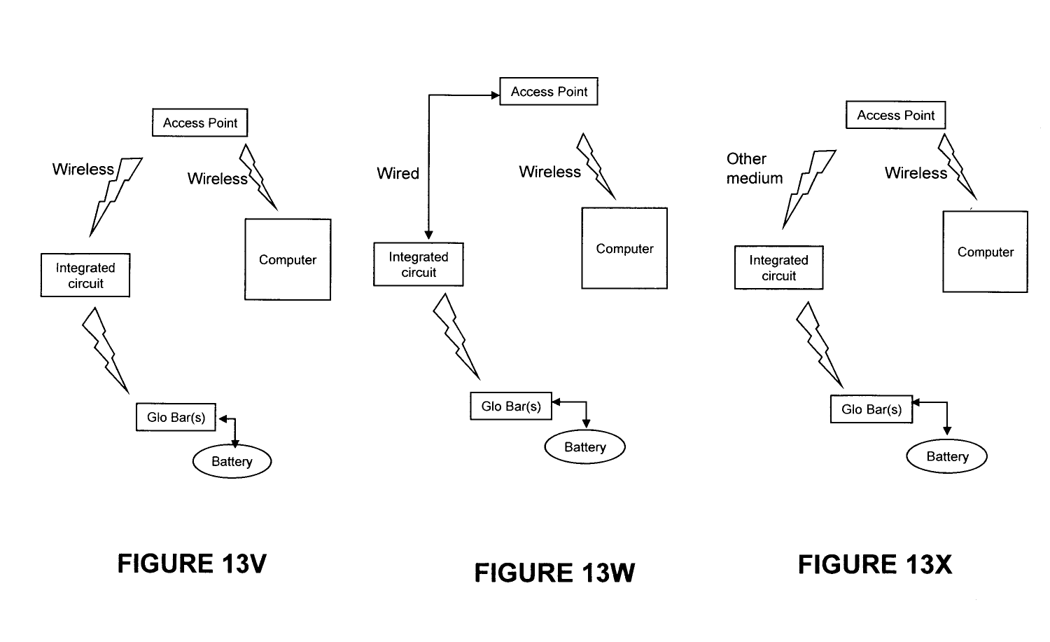

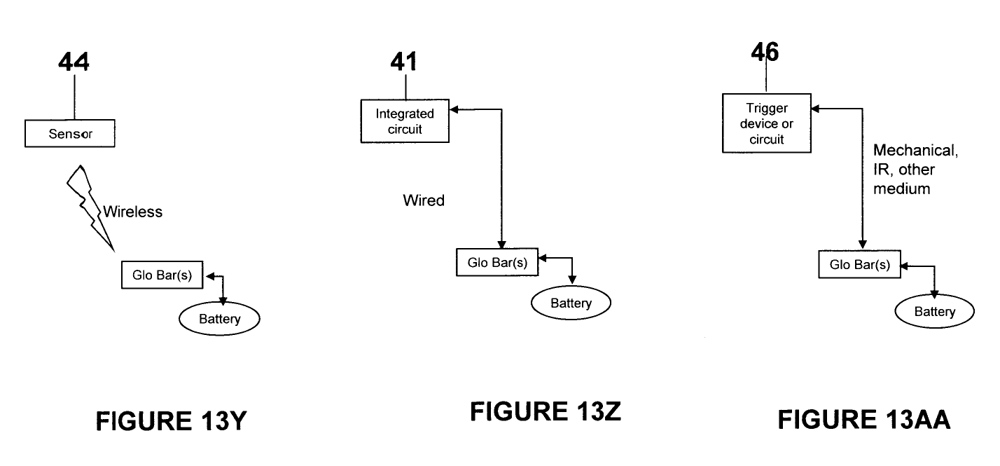

FIGS. 13A-13AA illustrate an example of the use of the attention garnering device in an environment such as a store. In these example of the attention garnering devices in a store environment, each device 20 may have the one or more attention elements 22 (known as a Glo Bars, for example) and may communicate with another device in order to receive data to be displayed on the display or to trigger the device 20 to activate/turn on/display information, etc. The device 20 also has a power source 38 and may or may not have an integrated circuit 41 that is coupled to the Glo Bar(s) 22 either wired (as shown in the examples in FIGS. 13A-13C, 13G-13I, 13M-13O, and 143-13U) or wirelessly (as shown in the examples in FIGS. 13D-13F, 13J-13L, 13P-13R and 13V-13X). The device 20 may be coupled by a medium 40, such as a wireless medium, wired medium, mechanical medium, another medium, etc. to another system 42. The other system 42 may be a computer that has an access point connected by a wire to the computer that allows the computer to communicate wirelessly or over another medium to the device 20 to download data for display by the device 20 (as shown in the examples in FIGS. 13A, 13C, 13D, 13F, 13G, 13I, 13J and 13L) or it may be a computer that has an access point connected wirelessly to the computer that allows the computer to communicate wirelessly or over another medium to the device 20 to download data for display by the device 20 (as shown in the examples in FIGS. 13M, 13O, 13P, 13R, 13S, 13U, 13V and 13X). The other system 42 also may be a computer that has an access point connected by a wire to the computer that allows the computer to communicate over a wire to the device 20 to download data for display by the device 20 (as shown in the examples in FIGS. 13B, 13E, 13H, 13K, 13G, 13I, 13J and 13L) or it may be a computer that has an access point connected wirelessly to the computer that allows the computer to communicate via a wire to the device 20 to download data for display by the device 20 (as shown in the examples in FIGS. 13N, 13Q, 13T, 13W). When used with the other system 42 that includes a computer, the device 20 may be used to automatically update information about each product in the store (price, discounts, etc.) in significantly less time and with minimal or no human involvement. Furthermore, the computer may be at a central remote site so that a large store chain can easily update its product information in a plurality of stores using the devices 20.

In addition, the other system 42 may be a sensor 44 (as shown in the example in FIG. 13Y) connected wirelessly to the device 20 that may be used to trigger the device 20 to perform some action, such as turning on, activating the Glo Bar(s) 22, dimming the Glo Bar(s) 22, etc where the sensor 44 may be for example a proximity sensor, a heat sensor, a motion sensor, a light sensitive sensor, etc. The device 20 also may be a standalone device (as shown in the example in FIG. 13Z) that operates autonomously. The other system 42 may also be trigger device or circuit 46 connected by a mechanical, IR or other medium to the Glo Bar(s) 22 to trigger the device 20 to perform some action, such as turning on, activating the Glo Bar(s) 22., dimming the Glo Bar(s) 22, etc. where the trigger circuit/device 44 may be for example a proximity circuit, a heat sensing circuit, a motion sensing circuit, a light sensitive circuit, etc. (as shown in the example in FIG. 13AA.)

While the foregoing has been with reference to a particular embodiment of the invention, it will be appreciated by those skilled in the art that changes in this embodiment may be made without departing from the principles and spirit of the invention, the scope of which is defined by the appended claims.

1. A device, comprising:
a housing;
a display panel on a front side of the housing that is capable of displaying at least one piece of information that is viewable when in front of the device;
one or more attention elements located on one or more sides of that housing that attract attention to the device and the display panel; and
a controller that controls the display panel and the one or more attention elements.

2. The device as in claim 1, wherein a portion of the housing is angled and at least one attention elements is located on the angled portion of the housing.

3. The device as in claim 1, wherein the housing is made of aluminum or plastic.

4. The device as in claim 1, wherein the display panel is a color display panel or a black and white display panel.

5. The device as in claim 1, wherein the controller controls a state of the one or more attention elements wherein the states are an on state, an off state or a flash state.

6. The device as in claim 5, wherein the controller controls the states of the one or more attention elements based on a programmed time schedule.

7. The device as in claim 5, wherein the controller controls the states of the one or more attention elements in response to a wired, optical fibre or wireless communication signal.

8. The device as in claim 1, wherein the one or more attention elements are replaceable.

9. The device as in claim 1 further comprising one or more lights on one or more of the sides of the housing.

10. The device as in claim 9, wherein the controller controls a state of the one or more lights wherein the states are an on state, an off state or a flash state.

11. The device as in claim 10, wherein the controller controls the state of the one or more lights based on a programmed time schedule.

12. The device as in claim 10, wherein the controller controls the states of the one or more lights based on a wired, optical fibre or wireless communication signal.

13. The device as in claim 1 further comprising a second display panel on the front of the housing.

14. A device comprising:
a housing having a back surface, a front surface having a display, and one or more side surfaces wherein the side surfaces are at an angle relative to the front surface wherein a relatively distant view of the housing includes at least one side surface so that a relatively distant viewer sees the at least one side surface and a relatively close viewer sees the display on the front surface.

15. The device of claim 14 further comprising a visual cue located on the at least one side surface that attracts attention for a relatively distant viewer.

16. The device as in claim 15, wherein the visual cue further comprises a blinking light, a change of character font or facing, a light emitter, a relatively high-contrast display, a varying color or intensity, a programmable or static message, a static image or an image including at least one changing feature or an image including movement or apparent movement.

17. The device as in claim 15, wherein the visual cue further comprises a colored surface, a lamp, a light-emitting diode, a colored material, a liquid crystal element, a lit surface, a programmable element, an active element or an element whose behavior is programmable via a central controller.

18. The device as in claim 15, wherein that visual cue is responsive to an external data source.

19. The device as in claim 14 further comprising a front visual cue located on at least a portion of the front surface wherein the visual cue is attractive of attention for that relatively close viewer.

20. The device as in claim 19, wherein the front visual cue further comprises a blinking light, a change of character font or facing, a light emitter, a relatively high-contrast display, a varying color or intensity, a programmable or static message, a static image or an image including at least one changing feature or an image including movement or apparent movement.

21. The device as in claim 19, wherein the front visual cue further comprises a colored surface, a lamp, a light-emitting diode, a colored material, a liquid crystal element, a lit surface, a programmable element, an active element or an element whose behavior is programmable via a central controller.

22. The device as in claim 19, wherein that front visual cue is responsive to an external data source.
